(19) United States
(12) Patent Application Publication
(10) Pub. No.: US 2021/0334112 A1
(43) Pub. Date: Oct. 28, 2021

(54) INFORMATION PROCESSING DEVICE AND LINKING METHOD

(71) Applicant: FUJITSU LIMITED, Kawasaki-shi (JP)

(72) Inventor: Toshihisa Anbai, Kawasaki (JP)

(73) Assignee: FUJITSU LIMITED, Kawasaki-shi (JP)

(21) Appl. No.: 17/182,276

(22) Filed: Feb. 23, 2021

(30) Foreign Application Priority Data
Apr. 27, 2020 (JP) 2020-078207

(51) Int. Cl. G06F 9/445; G06F 9/38; G06F 9/4401; G06F 21/57; H03K 3/027

(52) U.S. Cl. CPC G06F 9/44505; G06F 9/3857; H03K 3/027; G06F 21/572; G06F 9/4418

(57) ABSTRACT

An information processing device, includes a memory; and a processor coupled to the memory and the processor configured to: receive, from each of a plurality of unit devices included in the information processing device, a first output which indicates whether an operation is normal, each of the plurality of unit devices storing a firmware, receive, from each of the plurality of unit devices, a second output which indicates whether update of setting data used for operation management of the information processing device is completed, identify, from among the plurality of unit devices, a specific unit device by using the first output and the second output, and perform the operation management of the information processing device by using the firmware stored in the specific unit device.

### CROSS-REFERENCE TO RELATED APPLICATION

This application is based upon and claims the benefit of priority of the prior Japanese Patent Application No. 2020-78207, filed on Apr. 27, 2020, the entire contents of which are incorporated herein by reference.

### FIELD

The embodiments discussed herein are related to an information processing device and a linking method.

### BACKGROUND

An information processing device including a plurality of unit devices each including a central processing unit (CPU), a memory, and a transceiver, includes an overall management device that performs configuration setting and management of the entire information processing device. Furthermore, each unit device includes an individual management device that manages the unit device.

FIG. 14 is a diagram illustrating an example of such an information processing device. As illustrated in FIG. 14, an information processing device 8 includes system boards 80 as four unit devices represented by a system board #80 to a system board #83, and management boards (MMBs) 80a as two overall management devices represented by an MMB #80 and an MMB #81. Furthermore, the information processing device 8 includes a FAN 80b, a power supply 80c, and four IOUs 80d represented by an IOU #80 to an IOU #83.

Each system board 80 performs information processing such as execution of an application. The system board 80 includes a memory 81, two CPUs 82, a flash memory 83, a dual inline memory module (DIMM) 85, and two Ethernet (registered trademarks, the same applies hereinafter) transceivers 87. The flash memory 83 stores board management controller (BMC) firmware 833. The BMC firmware 833 is firmware that implements BMC that manages the system board 80 by being executed by the CPUs 82. The BMC performs configuration control of the CPUs 82, the DIMM 85, and the like mounted on the system board 80.

The MMBs 80a perform configuration setting and management of the entire information processing device 8. The MMBs 80a are redundant for reliability improvement. One of the MMBs 80a is used as an operational system (Active), and the other of the MMBs 80a is used as a standby system (Standby). The MMBs 80a are connected to the system board #80 to system board #83, the FAN 80b, the power supply 80c and the IOU #80 to IOU #83 by a control bus 80e, and controls these devices.

The MMBs 80a each include a memory 81a, a CPU 82a, a flash memory 83a, a non-volatile memory 84a, a switch 86a, an Ethernet transceiver 87a, and an Ethernet switch 88a.

The non-volatile memory 84a is, for example, a magnetoresistive random access memory (MRAM). The non-volatile memory 84a stores setting data 831 used for managing operation of the information processing device 8. The setting data 831 is transmitted from an active side to a standby side by using a data linkage bus 80f, and synchronization is made. The flash memory 83a stores MMB firmware 832. The MMB firmware 832 is firmware that performs configuration setting and management of the entire information processing device 8.

The switch 86a is connected to the control bus 80e, and connects the MMBs 80a to the system board #80 to system board #83, the FAN 80b, the power supply 80c, and the IOU #80 to IOU #83 when the MMBs 80a are active.

The FAN 80b is used for cooling the information processing device 8. The power supply 80c supplies power to the information processing device 8. The IOUs 80d are devices through which the information processing device 8 performs input and output.

The MMBs 80a configure partitions 89 represented by a partition #0 and a partition #1, by combining resources such as the system boards 80 and IOUs 80d. The setting data 831 includes information regarding the partitions 89. Furthermore, the MMBs 80a manage an operating state of the partitions 89, and perform storing of error logs, and the like.

Note that, as a conventional technology regarding configuration of an information processing device, there is a technology that implements a redundant configuration of a system management device that manages the information processing device at low cost with a simple mechanism. In this conventional technology, two information processing devices are each equipped with one system management device. Then, the two system management devices are connected together by a cable, and the system management devices mutually perform confirmation of respective working states periodically. Normally, the two system management devices monitor states of devices mounted on the respective information processing devices, but if one of the system management devices is no longer in the working state, the other of the system management devices monitors also the states of the devices mounted on the one of the information processing devices.

Furthermore, as a conventional technology regarding firmware upgrade, there is a transmission device that implements relief of a line failure that occurs during firmware upgrade. In this transmission device, before the firmware upgrade is performed, a CPU mounted on a line card to be upgraded makes a switching request to a line card on the opposite side paired with the line card to be upgraded. Here, the switching request refers to a request to perform switching to, as a master CPU, a CPU mounted on the line card on the opposite side, regarding a protection group set as the master CPU that takes the lead in executing switching control of a redundant line including an operation line and a spare line. For example, Japanese Laid-open Patent Publication No. 2006-260072, Japanese Laid-open Patent Publication No. 2010-093397, and the like are disclosed as related art.

### SUMMARY

According to an aspect of the embodiments, an information processing device, Includes a memory; and a processor coupled to the memory and the processor configured to: receive, from each of a plurality of unit devices included in the information processing device, a first output which indicates whether an operation is normal, each of the plurality of unit devices storing a firmware, receive, from each of the plurality of unit devices, a second output which indicates whether update of setting data used for operation management of the information processing device is completed, Identify, from among the plurality of unit devices, a specific unit device by using the first output and the second output, and perform the operation management of the information processing device by using the firmware stored in the specific unit device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an information processing device in which hardware is reduced from an information processing device illustrated in FIG. 14;

FIG. 2 is a diagram illustrating a configuration of an information processing device according to an embodiment;

FIG. 3 is a diagram illustrating a configuration related to three circuits added in a system board;

FIG. 4 is a diagram illustrating connections between system boards;

FIG. 5 is a diagram illustrating an operation flow of a main determination circuit;

FIG. 6A is a first diagram for explaining data linkage;

FIG. 6B is a second diagram for explaining the data linkage;

FIG. 6C is a third diagram for explaining the data linkage;

FIG. 6D is a fourth diagram for explaining the data linkage;

FIG. 6E is a fifth diagram for explaining the data linkage;

FIG. 6F is a sixth diagram for explaining the data linkage;

FIG. 6G is a seventh diagram for explaining the data linkage;

FIG. 6H is an eighth diagram for explaining the data linkage;

FIG. 7 is a diagram illustrating an operation flow at startup;

FIG. 8 is a diagram illustrating an operation flow when the system board fails;

FIG. 9 is a diagram illustrating an operation flow of the data linkage;

FIG. 10 is a diagram illustrating an operation flow when reception of update data falls during the data linkage;

FIG. 11 is a diagram illustrating data linkage by broadcasting;

FIG. 12 is a diagram illustrating an operation flow of the data linkage by broadcasting;

FIG. 13 is a diagram illustrating data linkage using a shared memory;

FIG. 14 is a diagram illustrating an example of an information processing device; and

FIG. 15 is a diagram illustrating a hardware configuration that implements a function of an MMB and a hardware configuration that implements a function of a BMC.

### DESCRIPTION OF EMBODIMENTS

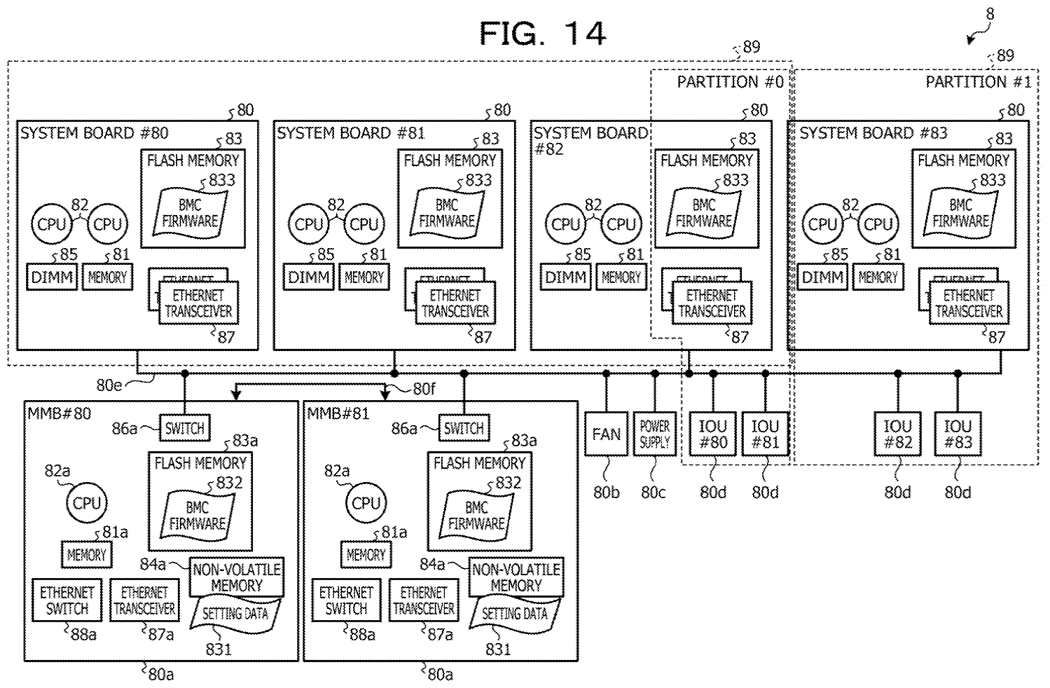

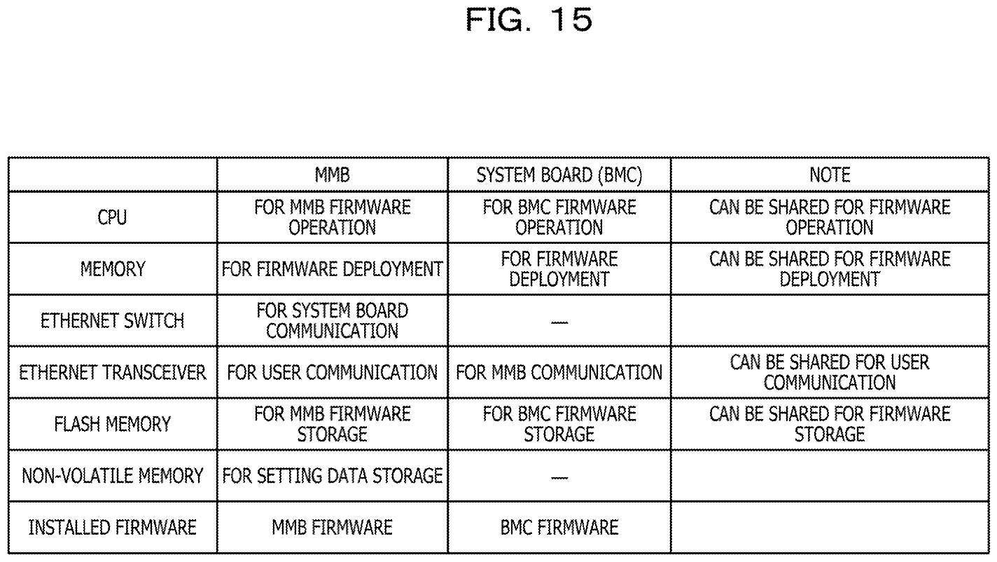

FIG. 15 is a diagram illustrating a hardware configuration that implements a function of an MMB 80a and a hardware configuration that implements a function of a BMC. As illustrated in FIG. 14, the MMB 80a includes a CPU 82a on which MMB firmware 832 operates, and the BMC includes a CPU on which BMC firmware 833 operates. The MMB 80a includes a memory 81a on which firmware (MMB firmware 832) is deployed, and the BMC includes a memory 81 on which firmware (BMC firmware 833) is deployed. The MMB 80a includes an Ethernet transceiver 87a used for communication with a user, and the BMC includes an Ethernet transceiver 87 used for communication with the MMB 80a. The MMB 80a includes a flash memory 83a that stores the MMB firmware 832, and the BMC includes a flash memory 83 that stores the BMC firmware 833.

As illustrated in FIG. 15, the hardware that implements the function of the MMB 80a and the hardware that implements the function of the BMC include the same hardware such as a CPU, a memory, an Ethernet transceiver, and a flash memory. Thus, an information processing device 8 includes the same hardware separately in the MMB 80a and a system board 80, whereby there is a problem that the amount of hardware is larger than that in a case where the hardware is shared.

In view of the above, it is desirable to reduce the amount of hardware in an information processing device.

Embodiments of an information processing device and a linking method disclosed by the present application will be described in detail below with reference to the drawings. Note that the embodiments do not limit the technology disclosed.

### Embodiments

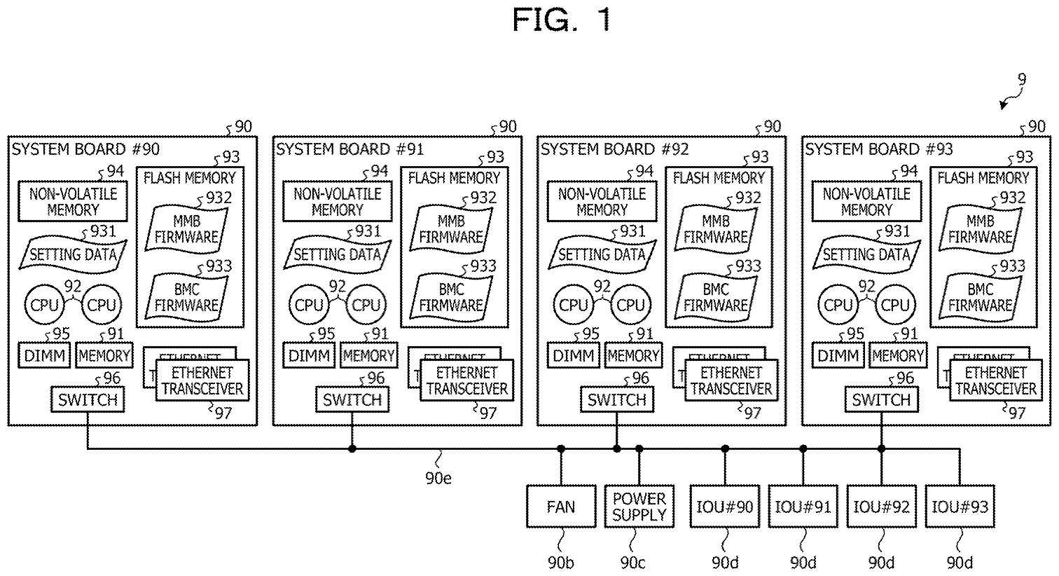

First, a description will be given of an information processing device in which the hardware is reduced from the information processing device 8 illustrated in FIG. 14. FIG. 1 is a diagram illustrating the information processing device in which the hardware is reduced from the information processing device illustrated in FIG. 14. As illustrated in FIG. 1, an information processing device does not include the MMB 80a as compared with the information processing device 8 illustrated in FIG. 14. The information processing device 9 includes four system boards 90 represented by a system board #90 to a system board #93, a FAN 90b, a power supply 90c, and four IOUs 90d represented by an IOU #90 to an IOU #93.

Each system board 90 performs information processing such as execution of an application. The system board 90 includes a memory 91, two CPUs 92, a flash memory 93, a non-volatile memory 94, a DIMM 95, a switch 96, and two Ethernet transceivers 97. The flash memory 93 stores MMB firmware and BMC firmware 933. The MMB firmware 932 is firmware that performs configuration setting and management of the entire information processing device 9. The BMC firmware 933 is firmware that implements BMC that manages the system board 90 by being executed by the CPUs 92. The BMC performs configuration control of the CPUs 92, the DIMM 95, and the like mounted on the system board 90.

The non-volatile memory 94 is, for example, an MRAM. The non-volatile memory 94 stores setting data 931 used for managing operation of the information processing device 9. The switch 96 is connected to a control bus 90e, and connects the system board 90 to other system boards 90, the FAN 90b, the power supply 90c, and the IOU #90 to IOU #93.

The FAN 90b is used for cooling the information processing device 9. The power supply 90c supplies power to the information processing device 9. The IOUs 90d are devices through which the information processing device 9 performs input and output.

As described above, the information processing device 9 stores the MMB firmware 932 in the flash memory 93. Then, the MMB firmware 932 is deployed to the memory 91 and executed by the CPUs 92. Furthermore, the system board 90 includes the non-volatile memory 94 that stores the setting data 931, and the switch 96 that connects to the other system boards 90, the FAN 90b, the power supply 90c, and the IOUs #90 to #93 via the control bus 90e. Thus, the information processing device 9 may make the MMB 80a unnecessary.

However, the information processing device 9 implements a redundant configuration, which is implemented by two MMBs 80a in the information processing device 8, by making one system board 90 active and making the remaining system boards 90 on standby. For this reason, when the active system board 90 fails, it is desirable to perform processing of determining the active system board 90 from the standby system boards 90 and switching the determined system board 90 to active.

Furthermore, in the information processing device 8, the MMB firmware 832 of the active MMB 80a transmits setting data 831 to the MMB firmware 832 of the standby MMB 80a, whereby synchronization of the setting data 831 is made. However, in the information processing device 9, the number of system boards 90 that need to be synchronized is large, and it takes time to make synchronization of the setting data 931.

As described above, in the information processing device 9, it is desirable to perform switching processing when the active system board 90 fails and synchronization processing of setting data 931 between the system boards. However, if such processing is performed by the MMB firmware 932, it takes time to perform the processing, and since the BMC firmware 933 is also in operation on the system board 90, the BMC firmware 933 is adversely affected.

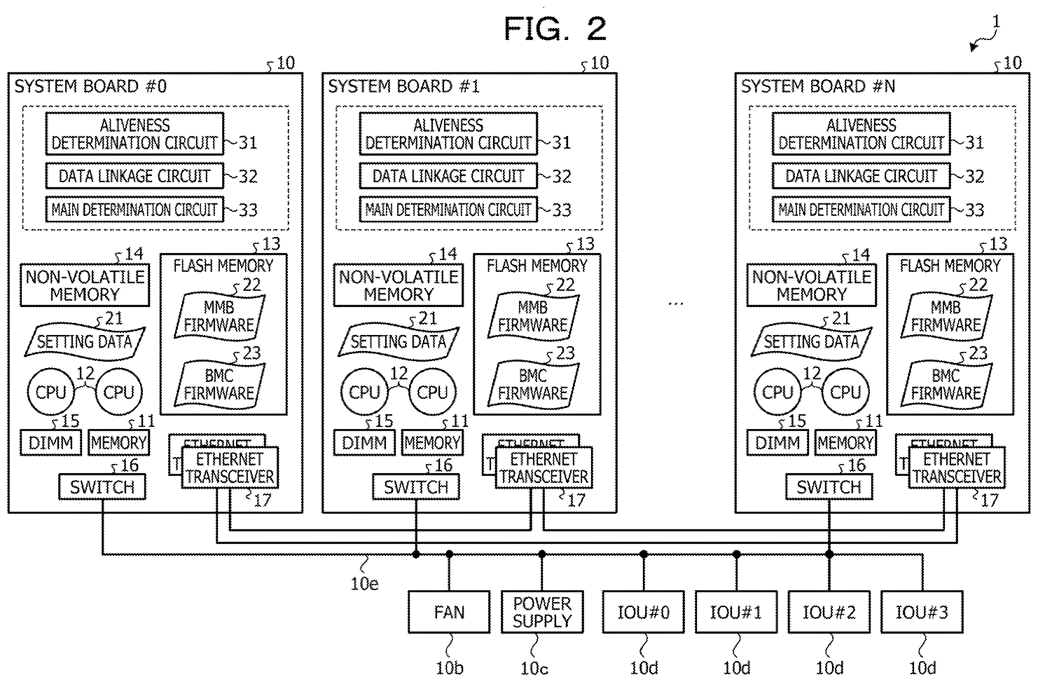

Thus, an information processing device according to the embodiment performs switching processing when the active system board fails and synchronization processing of setting data between the system boards, by hardware. FIG. 2 is a diagram illustrating a configuration of the information processing device according to the embodiment. As illustrated in FIG. 2, an information processing device 1 according to the embodiment includes a plurality of system boards 10 represented by a system board #0 to a system board #N (N is a positive integer), a FAN 10b, a power supply 10c, and four IOUs 10d represented by an IOU #0 to an IOU #3. Note that, although FIG. 2 includes the four IOUs 10d, the number of the IOUs 10d included in the information processing device 1 may be a number other than four.

Each system board 10 performs information processing such as execution of an application. The system board 10 includes a memory 11, two CPUs 12, a flash memory 13, a non-volatile memory 14, a DIMM 15, a switch 16, and two Ethernet transceivers 17. Note that, the system board 10 may include three or more CPUs 12. Furthermore, the system board 10 includes three circuits represented by an aliveness determination circuit 31, a data linkage circuit 32, and a main determination circuit 33. The aliveness determination circuit 31, the data linkage circuit 32, and the main determination circuit 33 are circuits added to the information processing device 1 as compared with the information processing device 9.

The memory 11 is a storage device on which firmware stored in the flash memory 13 is deployed. Of the two CPUs 12, one CPU 12 is a central processing unit that executes the firmware deployed in the memory 11. The other CPU 12 is a central processing unit that executes an application program and the like stored in the DIMM 15. The flash memory 13 stores MMB firmware and BMC firmware 23. The MMB firmware 22 is firmware that performs configuration setting and management of the entire information processing device 1. The BMC firmware 23 is firmware that implements BMC that manages the system board 10 by being executed by the CPUs 12. The BMC performs configuration control of the CPUs 12, the DIMM 15, and the like mounted on the system board 10.

The non-volatile memory 14 is, for example, an MRAM. The non-volatile memory 14 stores setting data 21 used for managing operation of the information processing device 1. The setting data 21 includes information regarding a partition.

The DIMM15 is a storage device that stores the application program and the like. The switch 16 is connected to a control bus 10e, and connects the system board 10 to other system boards 10, the FAN 10b, the power supply 10c, and the IOU #0 to IOU #3. The Ethernet transceivers 17 are communication devices that communicate with other system boards 10. The Ethernet transceivers 17 are also used for communication with the user. The FAN 10b is used for cooling the information processing device 1. The power supply 10c supplies power to the information processing device 1. The IOUs 10d are devices through which the information processing device 1 performs input and output.

The aliveness determination circuit 31 is hardware that determines whether or not the system board 10 is in normal operation. The data linkage circuit 32 is hardware that determines whether or not linkage of the setting data 21 is completed. Here, data linkage is to make synchronization of the setting data 21 with the active system board 10, that is, the main system board 10. The main determination circuit 33 is hardware that determines the main system board 10 from the standby system boards 10 when the main system board 10 fails.

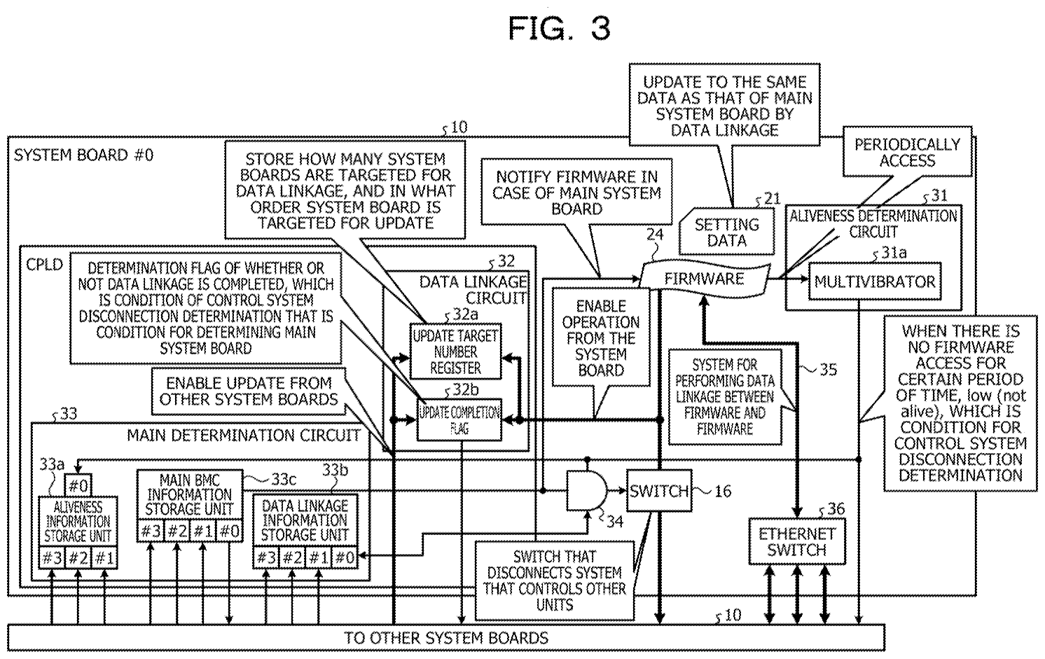

FIG. 3 is a diagram illustrating a configuration related to the three circuits added in the system board 10. FIG. 3 illustrates the system board #0 as an example. Furthermore, in FIG. 3, the number of the system boards 10 is four.

As illustrated in FIG. 3, the aliveness determination circuit 31 includes a multivibrator 31a. Firmware 24 periodically accesses the multivibrator 31a to set an output of the multivibrator 31a to high that indicates normal operation. Here, the firmware 24 is firmware in which the MMB firmware 22 and the BMC firmware 23 are integrated. When the system board 10 is not in normal operation, the firmware 24 does not access the multivibrator 31a, and thus the output of the multivibrator 31a is to be low. Thus, the output of the multivibrator 31a is a determination result of whether or not the system board 10 is in normal operation. The output of the multivibrator 31a is sent to the main determination circuit 33 and the other system boards 10.

The data linkage circuit 32 includes an update target number register 32a and an update completion flag 32b. The update target number register 32a stores the number of the system boards 10 that are synchronization targets of the setting data 21 and the order of synchronization for the system board 10. Note that, details of data linkage using the update target number register 32a will be described later. The update completion flag 32b is a flag indicating whether or not the synchronization of the setting data 21 is completed. The update target number register 32a and the update completion flag 32b can be set from the system board 10 or from the other system boards 10. An output of the update completion flag 32b is sent to the main determination circuit 33 and the other system boards 10.

The main determination circuit 33 includes an aliveness information storage unit 33a, a data linkage information storage unit 33b, and a main BMC information storage unit 33c. When the main system board 10 fails, the main determination circuit 33 determines a new main system board 10 on the basis of information stored in the aliveness information storage unit 33a, the data linkage information storage unit 33b, and the main BMC information storage unit 33c.

The aliveness information storage unit 33a stores, as aliveness information, whether or not each system board 10 is in normal operation, for all the system boards 10. The aliveness information storage unit 33a stores the output of the multivibrator 31a, for the system board 10 (system board #0), and stores outputs of the other system boards 10, for the other system boards 10 (system board #1 to system board #3).

The data linkage information storage unit 33b stores, as data linkage information, whether or not data linkage is completed for all the system boards 10. The data linkage information storage unit 33b stores a state of the update completion flag 32b, for the system board 10, and stores outputs of the other system boards 10, for the other system boards 10.

The main BMC information storage unit 33c stores, as main BMC information, whether or not each system board 10 is the main system board 10, for all the system boards 10. The main BMC information storage unit 33c stores a result determined by the main determination circuit 33, for the system board 10, and stores outputs of the other system boards 10, for the other system boards 10.

An AND circuit 34 controls the switch 16 on the basis of a logical product of pieces of information stored, for #0, by the aliveness information storage unit 33a, the data linkage information storage unit 33b, and the main BMC information storage unit 33c. For example, the AND circuit 34 connects the system board 10 to other units by enabling the switch 16 when the system board is alive (normal operation state), is in a state of data linkage completion, and is the main system board 10. Here, the other units are the other system boards 10, the FAN 10b, the power supply 10c, and the IOU #0 to IOU #3.

A route 35 is used when the firmware 24 communicates with the firmware 24 of each of the other system boards 10. The route 35 is connected to an Ethernet switch 36. The firmware 24 communicates with the firmware 24 of each of the other system boards 10 via the Ethernet switch 36. The route 35 is used for data linkage.

Note that, the data linkage circuit 32 and the main determination circuit 33 are implemented by a complex programmable logic device (CPLD).

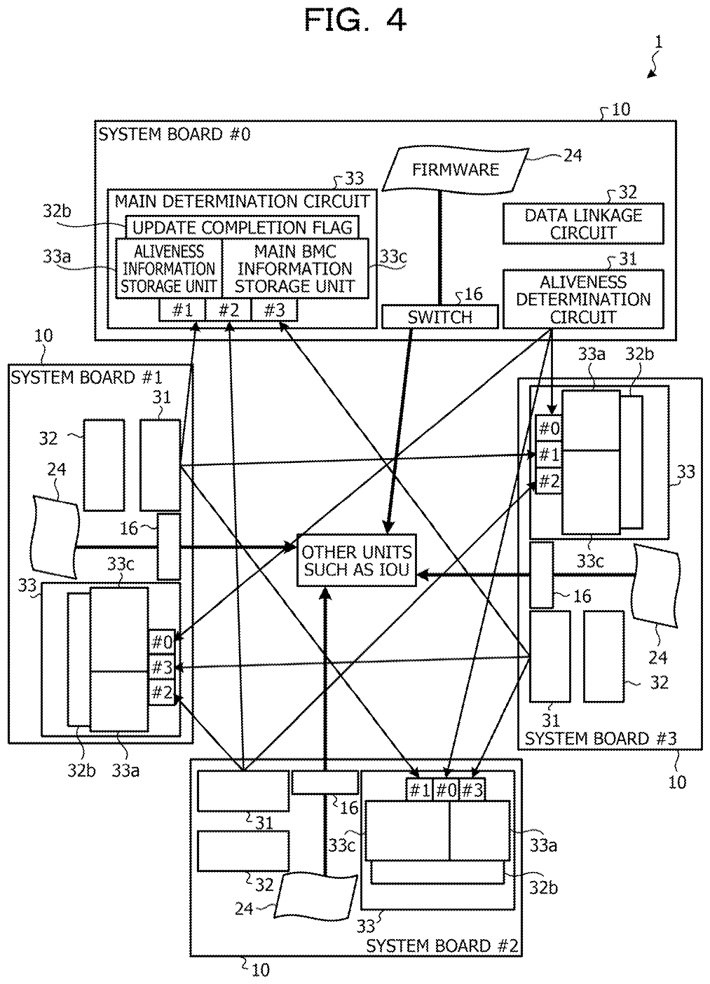

FIG. 4 is a diagram illustrating connections between the system boards 10. As illustrated in FIG. 4, in the information of the aliveness information storage unit 33a, outputs of the aliveness determination circuits 31 of the other system boards 10 are set, and in the information of the data linkage information storage unit 33b, outputs of the data linkage circuits 32 of the other system boards 10 are set. For example, regarding the aliveness information storage unit 33a of the system board #0, for pieces of information of #1, #2, and #3, the outputs of the aliveness determination circuits 31 of the system board #1, the system board #2, and the system board #3 are set, respectively. Note that, although omitted in FIG. 4, for the information of the main BMC information storage unit 33c, outputs of the main determination circuits 33 of the other system boards 10 are set.

Furthermore, the firmware 24 communicates with other units such as the FAN 10b, the power supply 10c, and the IOU #0 to IOU #3 via the switch 16.

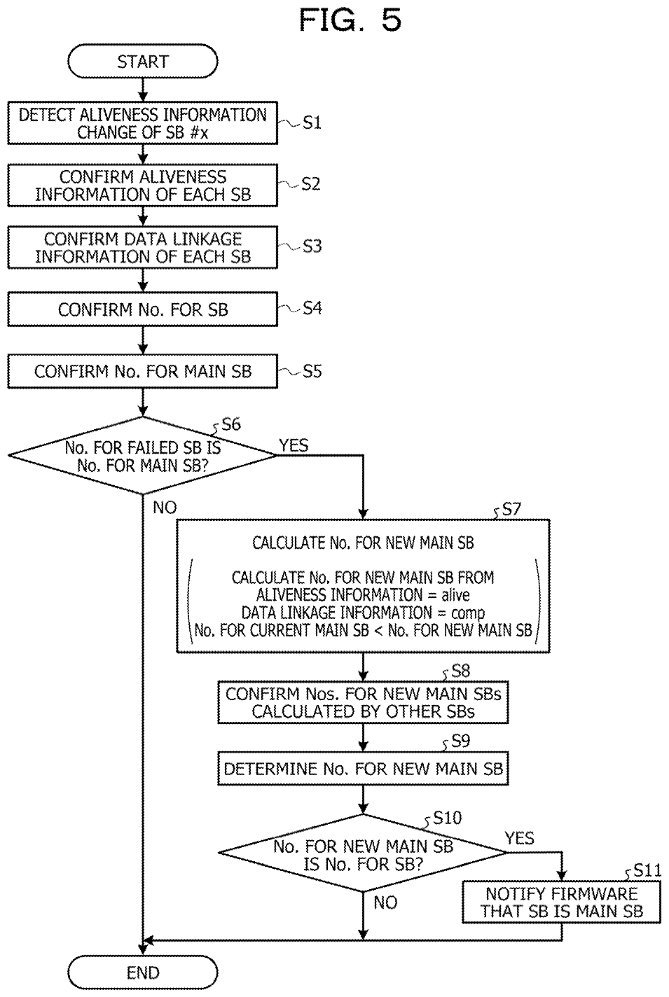

Next, an operation flow of the main determination circuit 33 will be described. FIG. 5 is a diagram illustrating the operation flow of the main determination circuit 33. Note that, in FIGS. 5, 7 to 10, and 12, SB represents the system board 10. Furthermore, an SB #x represents the x-th system board 10, and when the number of the system boards 10 is N, x is an integer from 0 to (N−1).

As illustrated in FIG. 5, the main determination circuit 33 detects an aliveness information change in the SB #x (step S1). Then, the main determination circuit 33 confirms the aliveness information of each SB (step S2), and confirms the data linkage information of each SB (step S3). Then, the main determination circuit 33 confirms a number (No.) for the SB (step S4), and confirms a No. for the main SB (step S5). Then, the main determination circuit determines whether or not a No. for a failed SB is the No. for the main SB (step S6), and when the No. for the failed SB is not the No. for the main SB, the operation is completed.

On the other hand, when the No. for the failed SB is the No. for the main SB, the main determination circuit 33 calculates a No. for a new main SB (step S7). The main determination circuit 33 calculates, as the No. for the new main SB, a number for an SB in which the aliveness information indicates aliveness (alive) and the data linkage information indicates completion (comp), the number being larger than the No. for the current main SB.

Then, the main determination circuit 33 confirms Nos. for new main SBs calculated by the other SBs (step S8). Basically, the Nos. for the main SBs calculated by the other SBs are the same as the No. for the new main SB calculated by the SB, but when some of the Nos. for the new main SBs are different due to a temporary error, the main determination circuit 33 determines the No. for the new main SB by a majority vote. Furthermore, when the No. is not determined by the majority vote, the main determination circuit 33 repeats recalculation of the No. for the new main SB and a recalculation request to the other SBs until the determination is made by the majority vote.

Then, the main determination circuit 33 determines the No. for the new main SB (step S9), and determines whether or not the No. for the new main SB is the No. for the SB (step S10). Then, when the No. for the new main SB is the No. for the SB, the main determination circuit 33 notifies the firmware 24 that the SB is the main SB (step S11).

As described above, the main determination circuit 33 determines the new main SB when the main SB falls, whereby the information processing device 1 may implement a redundant configuration.

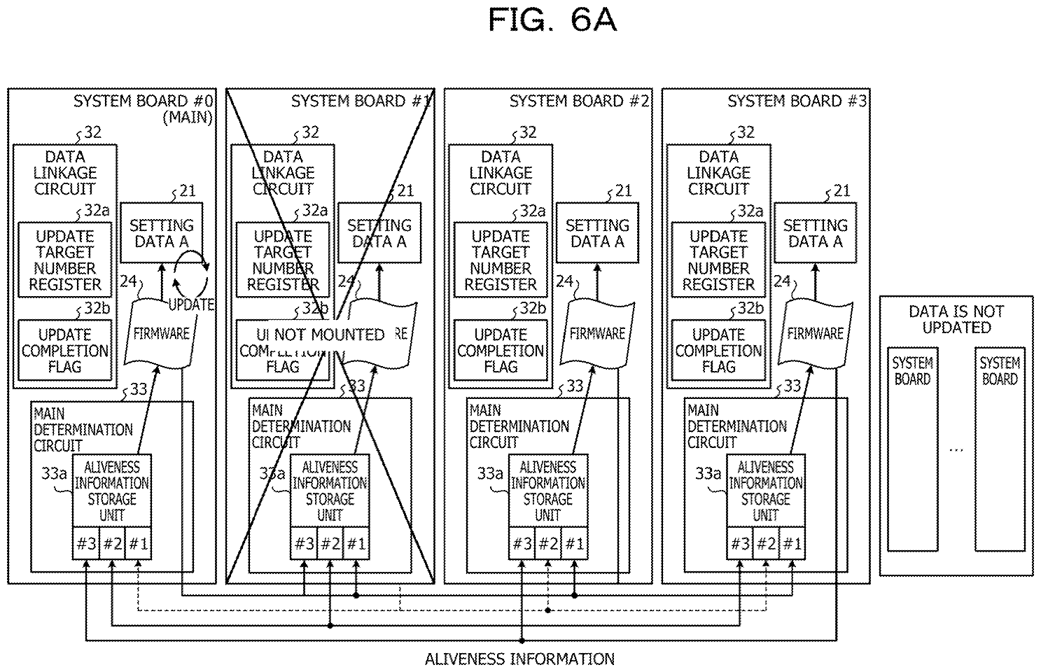

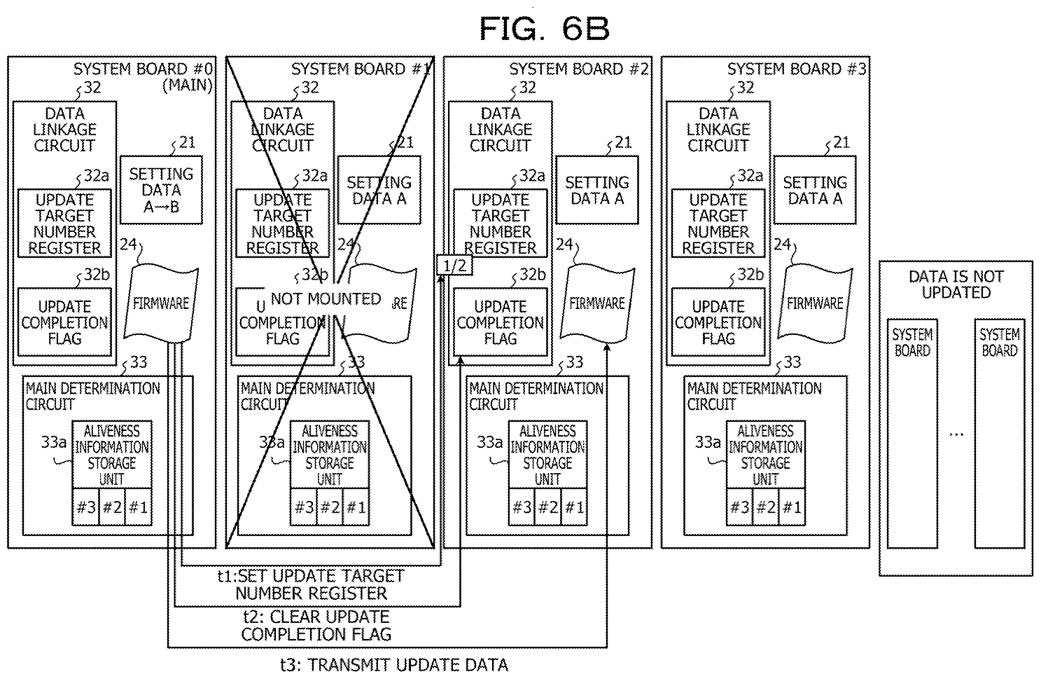

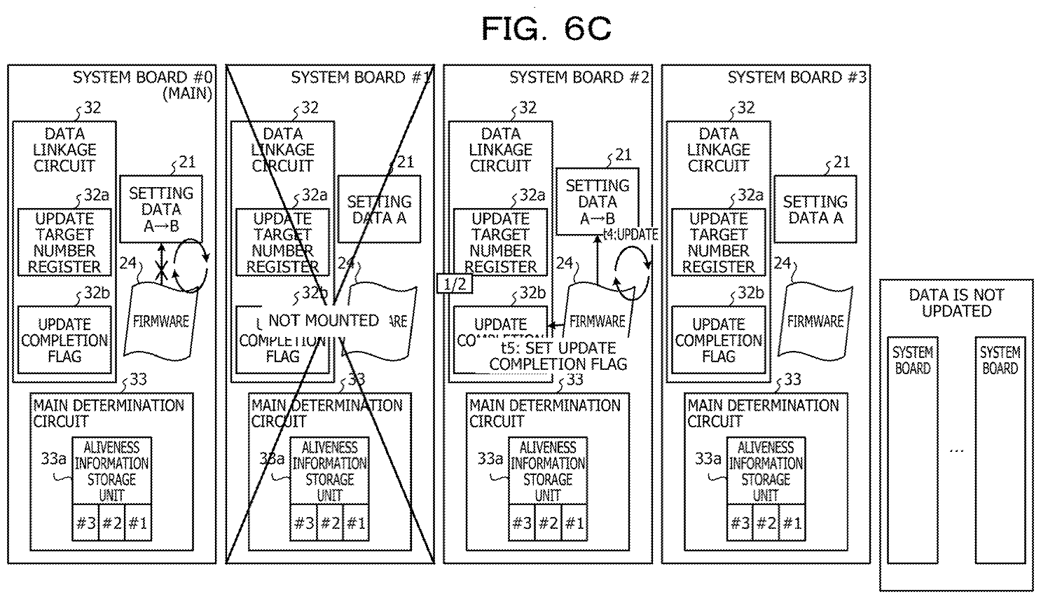

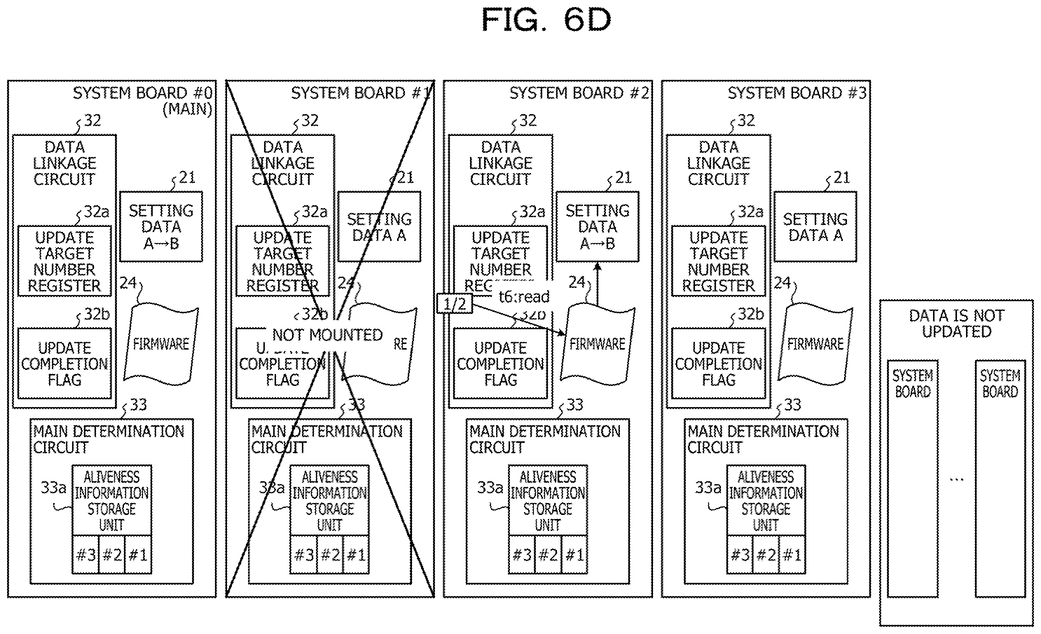

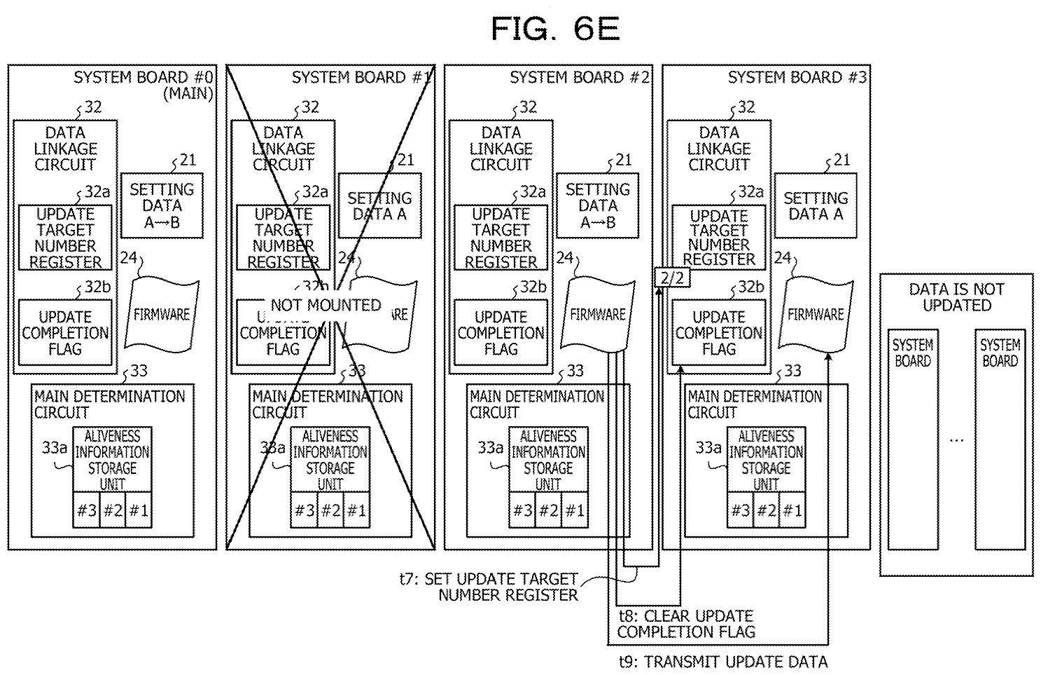

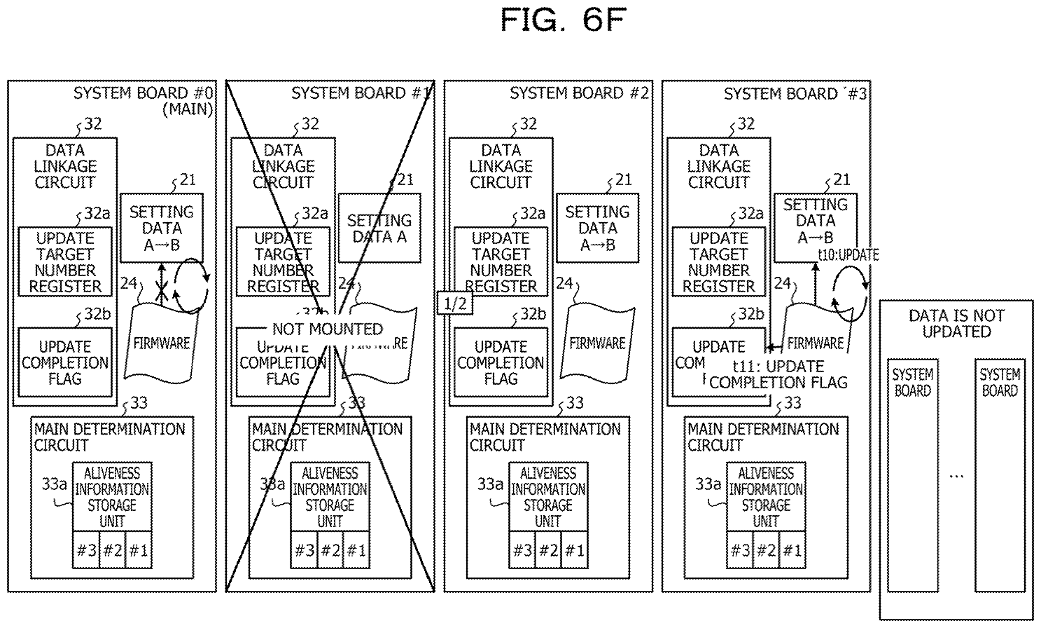

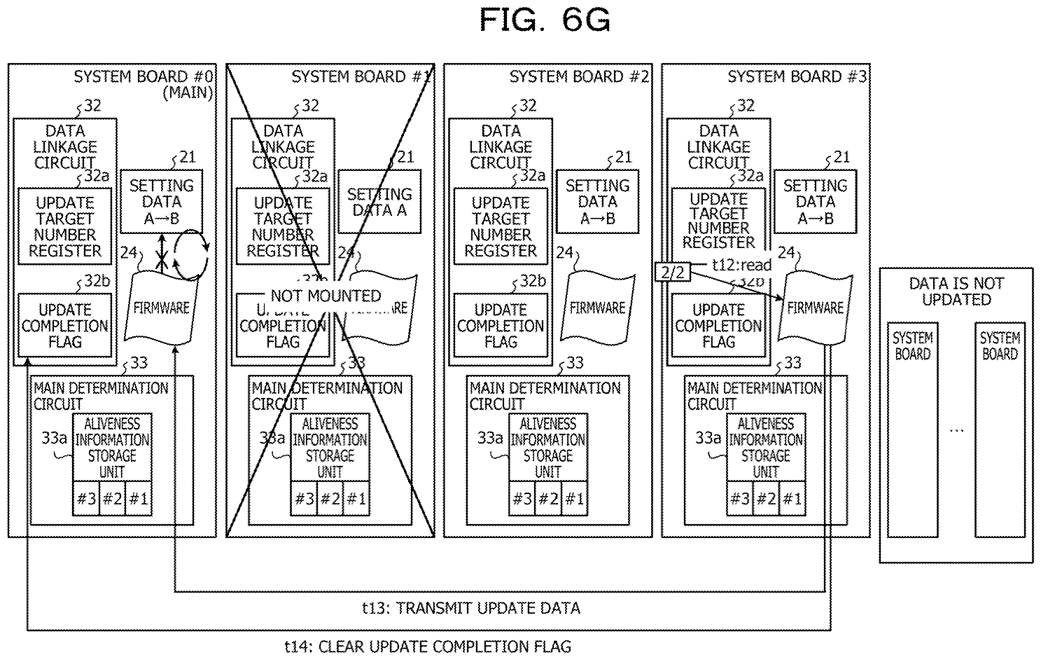

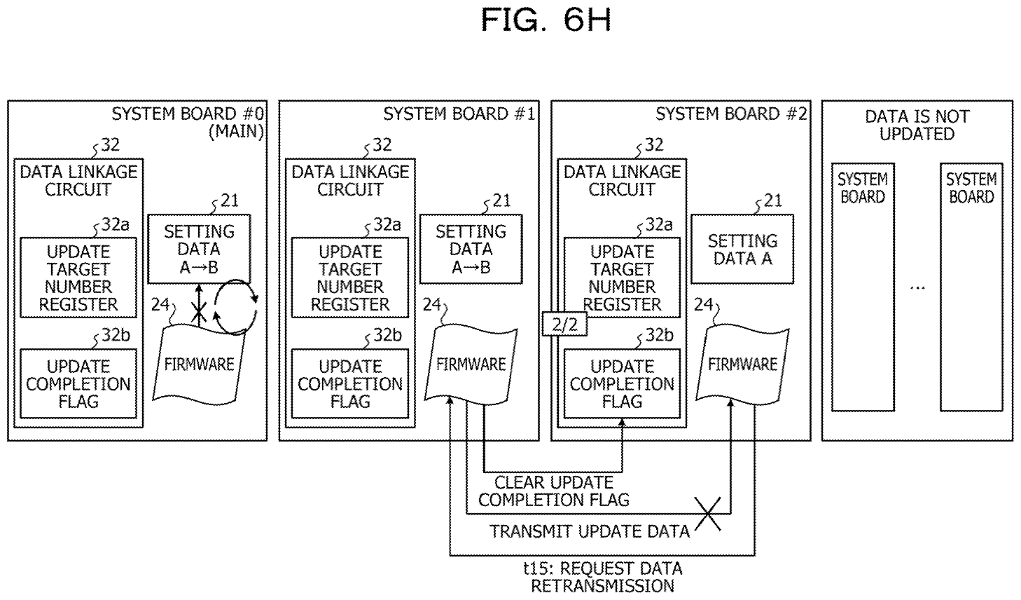

Next, the details of data linkage will be described. When the data linkage is performed for all the system boards 10, it takes a lot of time to complete the data linkage. Thus, the information processing device 1 performs the data linkage for some of the system boards 10. FIGS. 6A to 6H are diagrams for explaining the data linkage. In FIGS. 6A to 6H, the system board #0 is the main system board 10. The system board #0 performs the data linkage for two system boards 10 of the system board #2 and the system board #3. In FIGS. 6A to 6G, the system board #1 is not mounted. For this reason, the system board #1 is not a target of the data linkage. As described above, when there is the system board 10 that is not mounted, the information processing device 1 does not target the system board 10 that is not mounted even when the system board is the target of the data linkage if mounted.

For this reason, the information processing device 1 performs the data linkage by using the aliveness information. As illustrated in FIG. 6A, the firmware 24 of the system board #0 reads the aliveness information and confirms an aliveness state of each system board 10. When the system board 10 is not mounted, the aliveness information does not indicate aliveness. Then, the firmware 24 of the system board #0 performs the data linkage for the system boards 10 whose aliveness are confirmed. In FIG. 6A, the number of the system boards 10 whose aliveness are confirmed is two, and the firmware 24 of the system board #0 targets the system boards #2 and the system board #3 for the data linkage.

Then, as illustrated in FIG. 6B, setting data A of the main system board 10 is updated to setting data B. Then, the firmware 24 of the main system board 10 sets the number of the system boards 10 that are update targets and a number (update number) indicating the order in the update targets, in the update target number register 32a of the system board 10 that is a linkage target (t1). In FIG. 68, the firmware 24 of the system board #0 sets 2 as the number of the system boards 10 that are update targets, and 1 as the update number, in the update target number register 32a.

Then, the firmware 24 of the main system board 10 clears the update completion flag 32b of the linkage target (t2), and transmits update data to the linkage target (t3). In FIG. 6B, the firmware 24 of the system board #0 dears the update completion flag 32b of the system board #2, and transmits (t3) the setting data B to the system board #2.

Then, as illustrated in FIG. 6C, the firmware 24 (reception firmware 24) of the system board 10 that receives the update data updates the setting data 21 by using received data (t4), and sets update completion in the update completion flag 32b (t5). In FIG. 6C, the firmware 24 of the system board #2 updates the setting data A to the setting data B, and sets the update completion in the update completion flag 32b. At this time, the main system board 10 is released from data linkage processing, but restricts update of the setting data 21 of the main system board 10 until the data linkage is completed.

Then, as illustrated in FIG. 6D, the reception firmware 24 reads the update target number register 32a (t6), compares the number of update targets with the update number, thereby determining whether or not to transmit the update data to the next system board 10. When the number of update targets is larger than the update number, the reception firmware 24 transmits the update data to the next system board 10. At this time, as illustrated in FIG. 6E, the reception firmware 24 adds 1 to the update number and sets the update number in the update target number register 32a of the next system board 10 (t7), clears the update completion flag 32b of the next system board 10 (t8), and transmits the update data (t9).

In FIGS. 6D and 6E, the firmware 24 of the system board #2 compares 2 (number of update targets) with 1 (update number), and transmits the setting data B to the system board #3 since the number of update targets is larger than the update number. At this time, 2 is set for the number of update targets and the update number of the system board #3, and the update completion flag 32b of the system board #3 is cleared.

Then, as illustrated in FIG. 6F, the reception firmware 24 updates the setting data 21 by using received data (t10), and sets update completion in the update completion flag 32b (t11). In FIG. 6F, the firmware 24 of the system board #3 updates the setting data A to the setting data B, and sets the update completion in the update completion flag 32b.

Then, as illustrated in FIG. 6G, the reception firmware 24 reads the update target number register 32a (t12), compares the number of update targets with the update number, thereby determining whether or not to transmit the update data to the next system board 10. When the number of update targets is equal to the update number, the reception firmware 24 transmits the update data to the main system board 10 (t13), and dears the update completion flag 32b of the main system board 10 (t14). In FIG. 6G, the firmware 24 of the system board #3 compares 2 (number of update targets) with 2 (update number), and transmits the setting data B to the system board #0 since the number of update targets is equal to the update number. At this time, the update completion flag 32b of the system board #0 is cleared.

As described above, the information processing device 1 performs the data linkage by a relay method, thereby returning the update data to the main system board 10. Thus, the main system board 10 may know completion of the data linkage. Note that, the main system board 10 discards the transmitted update data.

Furthermore, when a problem occurs during the data linkage processing, the reception firmware 24 issues a retransmission request to the transmission side (t15), as illustrated in FIG. 6H. FIG. 6H illustrates a case where the system board #2 issues the retransmission request to the system board #1. As described above, since a problem may occur during the data linkage processing, the main system board 10 restricts update of the setting data until the data linkage is completed.

Next, an operation flow of the information processing device 1 will be described. Note that, the following operation flow illustrates a case where the information processing device 1 includes four system boards 10 represented by the SB #0 to the SB #3. Furthermore, in the following operation flow, processing in a shaded step is performed by hardware. On the other hand, processing in an unshaded step is performed by the firmware 24 except for processing in step S32.

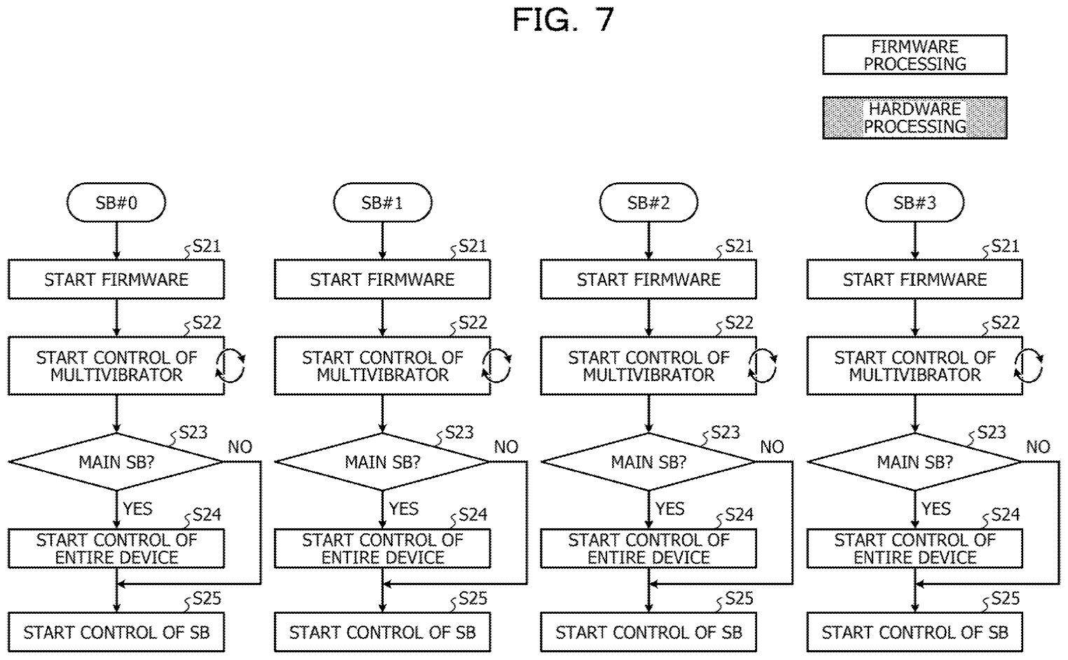

FIG. 7 is a diagram illustrating an operation flow at startup. As illustrated in FIG. 7, the SB #0 to the SB #3 have the same operation flow at startup, and thus the operation of the SB #0 will be described here as an example. When the power supply 10c is turned on, the firmware 24 of the SB #0 is started (step S21).

Then, the firmware 24 of the SB #0 starts control of the multivibrator 31a (step S22), and determines whether or not the SB #0 is the main SB (step S23). Then, when the SB #0 is the main SB, the firmware 24 of the SB #0 starts control of the entire device (step S24). Then, the firmware 24 of the SB #0 starts control of the SB #0 (step S25).

As described above, since the firmware 24 of the main SB performs the control of the entire device, the information processing device 1 may make the MMB 80a unnecessary.

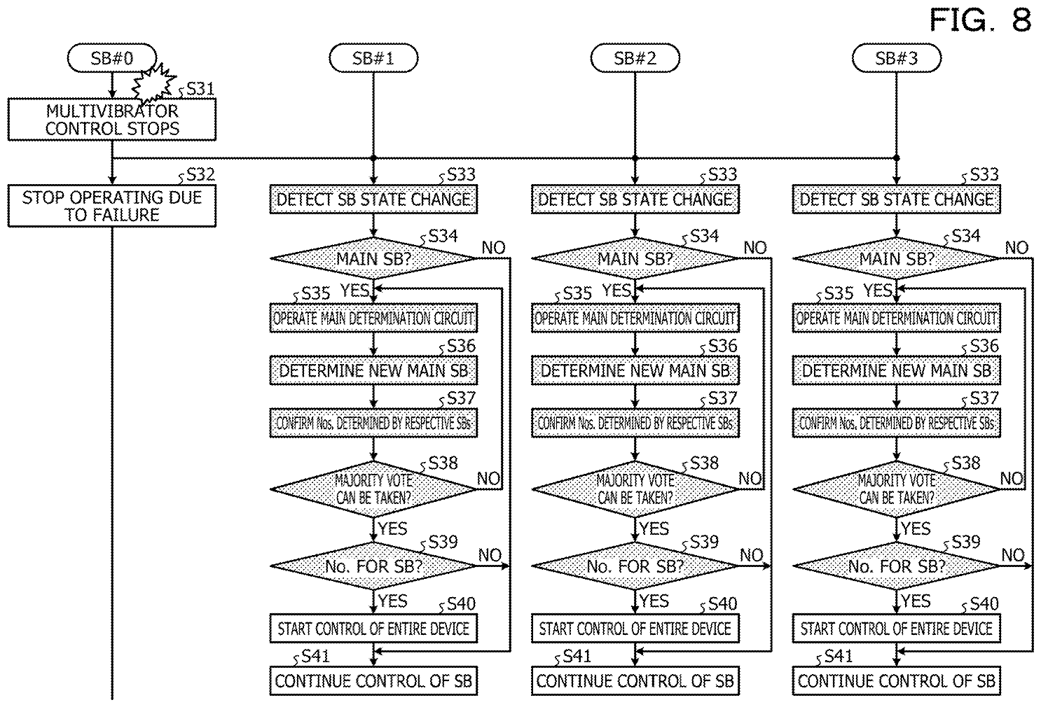

FIG. 8 is a diagram illustrating an operation flow when the system board 10 falls. FIG. 8 illustrates a case where the SB #0 fails. As illustrated in FIG. 8, the SB #1 to the SB #3 have the same operation flow when the SB #0 falls, and thus the operation of the SB #1 will be described here as an example.

When the SB #0 fails, multivibrator control in the SB #0 stops (step S31). Furthermore, the SB #0 stops operating due to a failure (step S32). On the other hand, the SB #1 detects a state change of the SBs (step S33). Then, the SB #1 determines whether or not a failed SB is the main SB (step S34), and when the failed SB is not the main SB, the SB #1 proceeds to step S41.

On the other hand, when the failed SB is the main SB, the SB #1 operates the main determination circuit 33 (step S35) and determines a new main SB (step S36). Then, the SB #1 confirms the Nos. determined by respective SBs (step S37), and determines whether or not a majority vote can be taken for the Nos. determined by the respective SBs (step S38). Then, when the majority vote is not taken, the SB #1 returns to step S35.

On the other hand, when the majority vote can be taken, the SB #1 determines whether or not the No. determined by the majority vote is the No. for the SB #1 (step S39), and when the No. is not the No. for the SB #1, the SB #1 proceeds to step S41. On the other hand, when the No. determined by the majority vote is the No. for the SB #1, the SB #1 starts the control of the entire device (step S40). Then, the SB #1 continues the control of the SB #1 (step S41).

Note that, the SBs perform other processing steps by hardware except the processing of step S40 and step S41. As described above, when the main SB falls, the new main SB is determined by the hardware, so that the information processing device 1 may determine the new main SB at high speed.

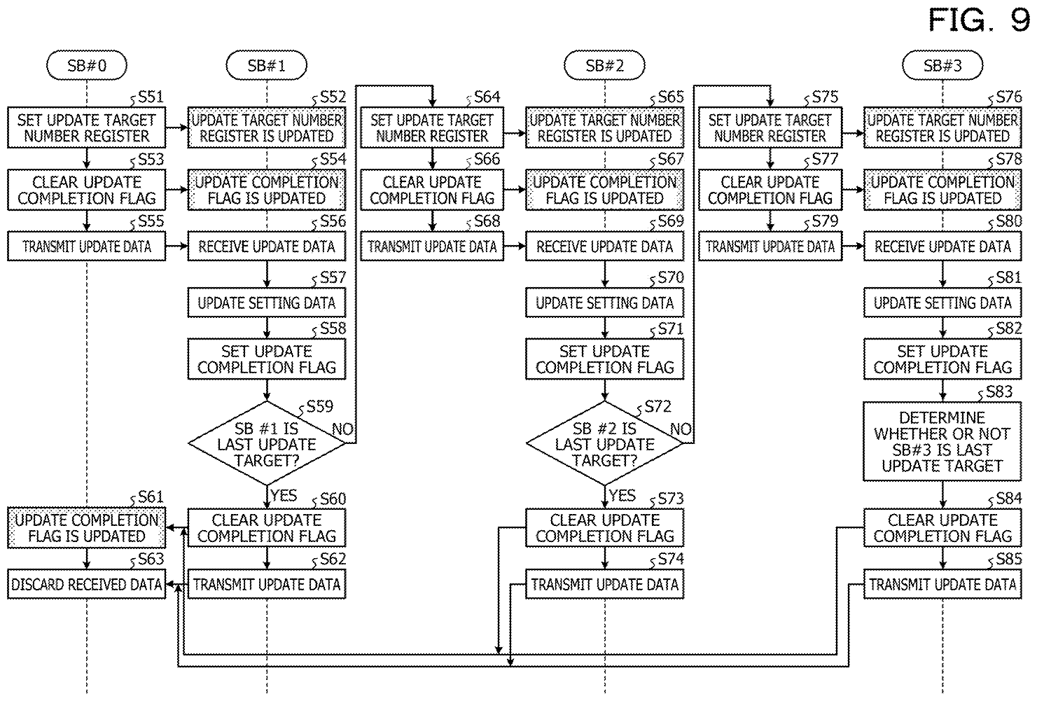

FIG. 9 is a diagram illustrating an operation flow of the data linkage. Note that, in FIG. 9, the SB #0 is the main SB. As illustrated in FIG. 9, the SB #0 sets the update target number register 32a of the SB #1 (step S51). Then, the update target number register 32a of the SB #1 is updated (step S52). Then, the SB #0 dears the update completion flag 32b of the SB #1 (step S53). Then, the update completion flag 32b of the SB #1 is updated (step S54).

Then, the SB #0 transmits update data of the setting data 21 to the SB #1 (step S55). Then, the SB #1 receives the update data (step S56), and updates the setting data 21 (step S57). Then, the SB #1 sets the update completion flag 32b (step S58), and determines whether or not the SB #1 is the last update target (step S59). Then, when the SB #1 is the last update target, the SB #1 dears the update completion flag 32b of the SB #0 (step S60). Then, the update completion flag 32b of the SB #0 is updated (step S61). Then, the SB #1 transmits the update data to the SB #0 (step S62). Then, the SB #0 receives and discards the update data (step S63), and completes the data linkage.

On the other hand, when the SB #1 is not the last update target, the SB #1 sets the update target number register 32a of the SB #2 (step S64). Then, the update target number register 32a of the SB #2 is updated (step S65). Then, the SB #1 dears the update completion flag 32b of the SB #2 (step S66). Then, the update completion flag 32b of the SB #2 is updated (step S67).

Then, the SB #1 transmits the update data of the setting data 21 to the SB #2 (step S68). Then, the SB #2 receives the update data (step S69), and updates the setting data 21 (step S70). Then, the SB #2 sets the update completion flag 32b (step S71), and determines whether or not the SB #2 is the last update target (step S72). Then, when the SB #2 is the last update target, the SB #2 dears the update completion flag 32b of the SB #0 (step S73). Then, the update completion flag 32b of the SB #0 is updated (step S61). Then, the SB #2 transmits the update data to the SB #0 (step S74). Then, the SB #0 receives and discards the update data (step S63), and completes the data linkage.

On the other hand, when the SB #2 is not the last update target, the SB #2 sets the update target number register 32a of the SB #3 (step S75). Then, the update target number register 32a of the SB #3 is updated (step S76). Then, the SB #2 dears the update completion flag 32b of the SB #3 (step S77). Then, the update completion flag 32b of the SB #3 is updated (step S78).

Then, the SB #2 transmits the update data of the setting data 21 to the SB #3 (step S79). Then, the SB #3 receives the update data (step S80), and updates the setting data 21 (step S81). Then, the SB #3 sets the update completion flag 32b (step S82), and determines whether or not the SB #3 is the last update target (step S83). Then, when the SB #3 is the last update target, the SB #3 dears the update completion flag 32b of the SB #0 (step S84). Then, the update completion flag 32b of the SB #0 is updated (step S61). Then, the SB #3 transmits the update data to the SB #0 (step S85). Then, the SB #0 receives and discards the update data (step S63), and completes the data linkage.

As described above, the information processing device 1 may update the setting data 21 of the target of the data linkage by transmitting the update data by the relay method.

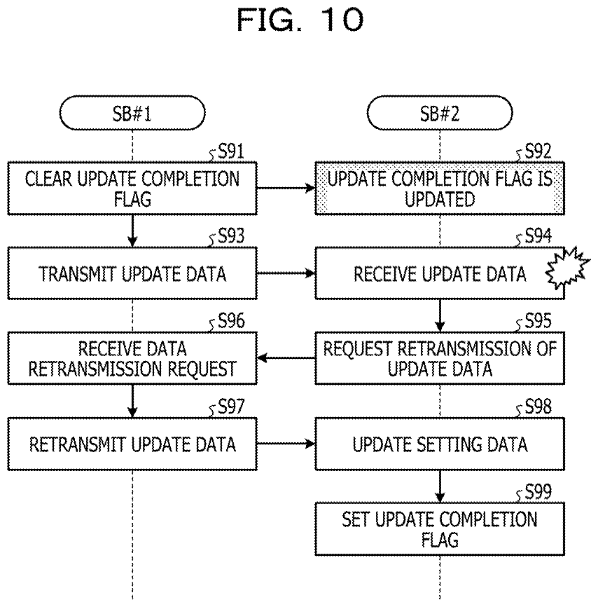

FIG. 10 is a diagram illustrating an operation flow when reception of update data fails during the data linkage. As illustrated in FIG. 10, the SB #1 clears the update completion flag 32b of the SB #2 (step S91). Then, the update completion flag 32b of the SB #2 is updated (step S92). Then, the SB #1 transmits the update data of the setting data 21 to the SB #2 (step S93). Here, the SB #2 fails to receive the update data (step S94).

Then, the SB #2 requests the SB #1 to retransmit the update data (step S95). Then, the SB #1 receives the retransmission request (step S96), and retransmits the update data to the SB #2 (step S97). Then, the SB #2 updates the setting data 21 (step S98), and sets the update completion flag 32b (step S99). Then, the SB #2 proceeds to the operation of determining whether or not the SB #2 is the last update target.

As described above, when failing to receive the update data, the SBs may acquire the update data by requesting retransmission.

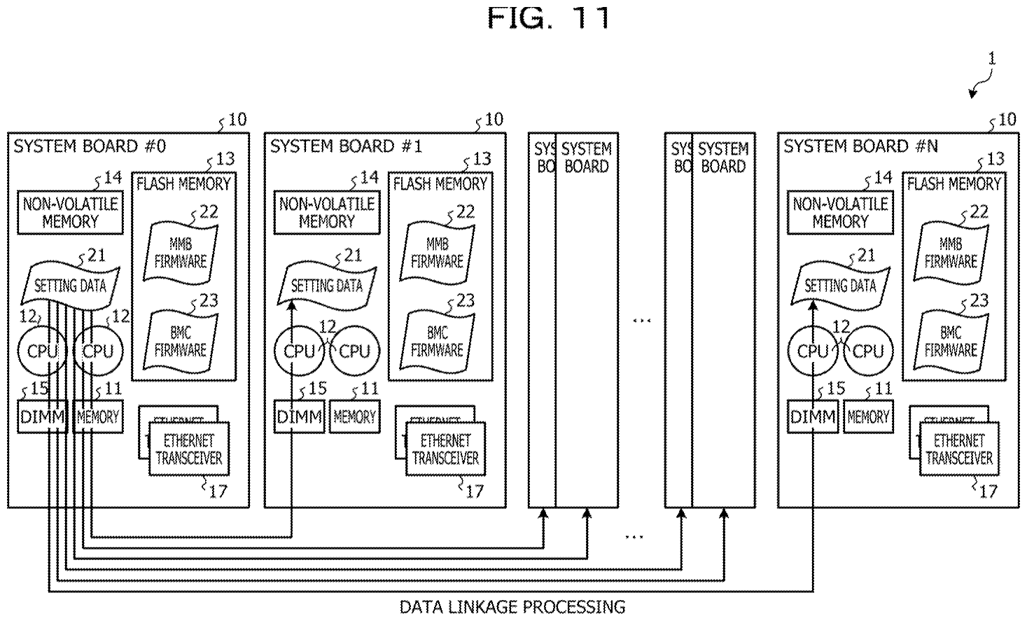

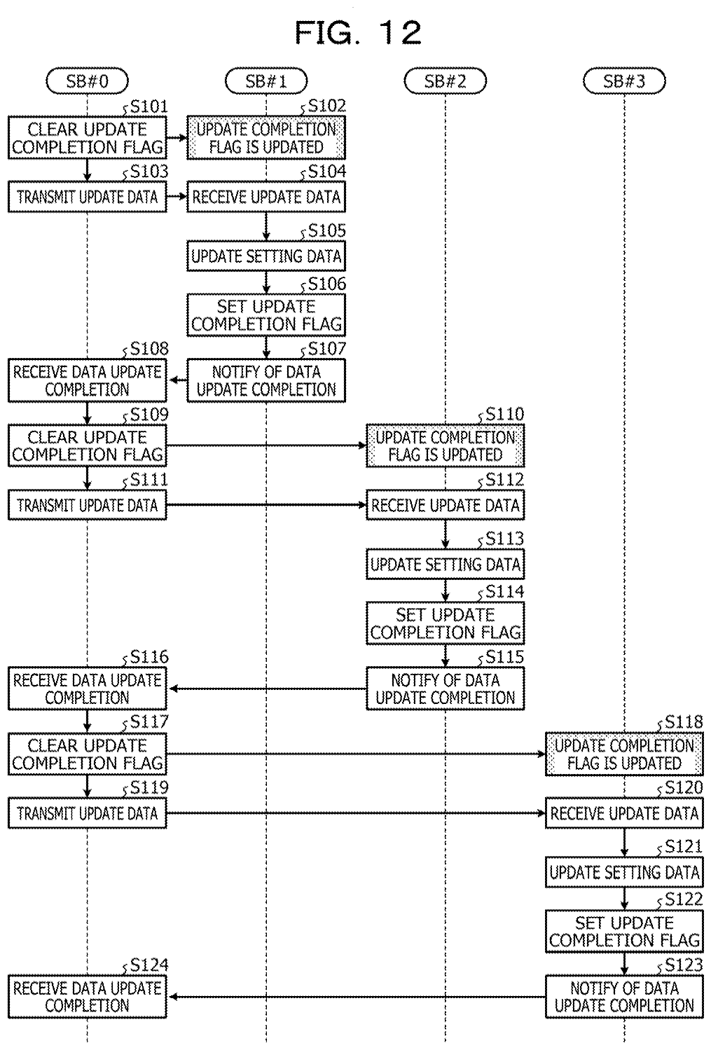

Note that, the information processing device 1 may transmit the update data of the setting data 21 by broadcasting instead of the relay method. FIG. 11 is a diagram illustrating data linkage by broadcasting, and FIG. 12 is a diagram illustrating an operation flow of the data linkage by broadcasting. In FIGS. 11 and 12, the system board #0 (SB #0) is the main system board 10. Furthermore, in FIG. 11, the system board #1 and the system board #N are the update targets, and in FIG. 12, the SB #1 to the SB #3 are the update targets.

As illustrated in FIG. 11, the system board #0 broadcasts update data to the system board #1 to the system board #N. The system board #1 and the system board #N receive the update data and update the setting data 21. On the other hand, the other system boards 10 discard the received update data.

Furthermore, as illustrated in FIG. 12, the SB #0 dears the update completion flag 32b of the SB #1 (step S101). Then, the update completion flag 32b of the SB #1 is updated (step S102). Then, the SB #0 transmits the update data of the setting data 21 to the SB #1 (step S103). Then, the SB #1 receives the update data (step S104), and updates the setting data 21 (step S105). Then, the SB #1 sets the update completion flag 32b (step S106), and notifies the SB #0 of data update completion (step S107). Then, the SB #0 receives the data update completion (step S108).

Furthermore, the SB #0 dears the update completion flag 32b of the SB #2 (step S109). Then, the update completion flag 32b of the SB #2 is updated (step S110). Then, the SB #0 transmits the update data of the setting data 21 to the SB #2 (step S111). Then, the SB #2 receives the update data (step S112), and updates the setting data 21 (step S113). Then, the SB #2 sets the update completion flag 32b (step S114), and notifies the SB #0 of data update completion (step S115). Then, the SB #0 receives the data update completion (step S116).

Furthermore, the SB #0 dears the update completion flag 32b of the SB #3 (step S117). Then, the update completion flag 32b of the SB #3 is updated (step S118). Then, the SB #0 transmits the update data of the setting data 21 to the SB #3 (step S119). Then, the SB #3 receives the update data (step S120), and updates the setting data 21 (step S121). Then, the SB #3 sets the update completion flag 32b (step S122), and notifies the SB #0 of data update completion (step S123). Then, the SB #0 receives the data update completion (step S124).

As described above, the information processing device 1 may perform the data linkage also by broadcasting the update data by the main system board 10. The broadcast method is effective when the data linkage processing does not interfere with normal operation, such as when the amount of updated data is small.

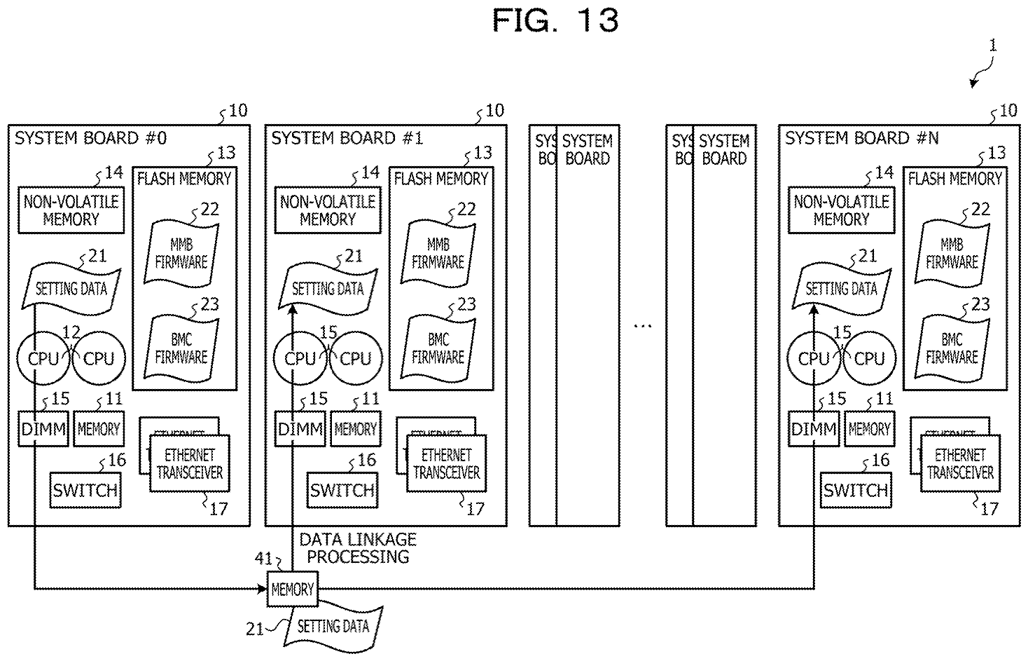

FIG. 13 is a diagram illustrating data linkage using a shared memory. In FIG. 13, the system board #0 is the main system board 10, and the system board #1 and the system board #N are update targets. As illustrated in FIG. 13, the system board #0 stores the setting data 21 in a memory 41 arranged outside of all the system boards 10. Then, when being the main system board 10 and starting operation, the system board #1 and the system board #N read the setting data 21 from the memory 41 and update the setting data 21 of the system board #1 and the system board #N.

As described above, the information processing device 1 may perform data linkage by using the memory 41 arranged outside of all the system boards 10. When there are no restrictions on the hardware configuration, or when it is not significant to make the setting data 21 redundant, the information processing device 1 may perform data linkage by such a shared memory method.

As described above, in the embodiment, the aliveness determination circuit 31 determines whether or not the system board 10 is in normal operation, and the data linkage circuit 32 determines whether or not linkage of the setting data 21 is completed. Then, when the main system board fails, the main determination circuit 33 determines a new main system board on the basis of determination results of the aliveness determination circuits 31 and the data linkage circuits 32 of the system board 10 and the other system boards 10. Then, the firmware 24 of the new system board 10 manages the information processing device 1. Thus, the information processing device 1 may make the MMB 80a unnecessary, and reduce the amount of hardware.

Furthermore, in the embodiment, the aliveness determination circuit 31 includes the multivibrator 31a, and the firmware 24 periodically accesses the multivibrator 31a to set the output of the multivibrator 31a to high that indicates normal operation. Thus, the aliveness determination circuit 31 may determine whether or not the system board 10 is in normal operation.

Furthermore, in the embodiment, the data linkage circuit 32 transfers the setting data 21 to the system boards 10 that are linkage targets by the relay method by using the update target number register 32a, so that a load on the main system board 10 may be reduced.

Furthermore, in the embodiment, the aliveness information storage unit 33a stores the determination result of the aliveness determination circuit 31 for the system board 10 and the other system boards 10. Furthermore, the data linkage information storage unit 33b stores the determination result of the data linkage circuit 32 for the system board 10 and the other system boards 10. Then, the main determination circuit 33 determines, as the main system board 10, the system board 10 in which the aliveness information storage unit 33a Indicates that the system board 10 is in normal operation, and the data linkage information storage unit 33b indicates that the data linkage is completed. Thus, the main determination circuit 33 may appropriately determine the main system board 10.

Furthermore, in the embodiment, the case has been described where the plurality of system boards 10 is included, but the information processing device 1 may include a plurality of unit devices each including: a processing device such as a CPU; a memory; and a transceiver.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device, comprising:
a memory; and
a processor coupled to the memory and the processor configured to:
receive, from each of a plurality of unit devices included in the information processing device, a first output which indicates whether an operation is normal, each of the plurality of unit devices storing a firmware,
receive, from each of the plurality of unit devices, a second output which indicates whether update of setting data used for operation management of the information processing device is completed,
identify, from among the plurality of unit devices, a specific unit device by using the first output and the second output, and
perform the operation management of the information processing device by using the firmware stored in the specific unit device.

2. The information processing device according to claim 1, further comprising
a multivibrator that outputs a determination result of whether or not the unit device is in normal operation, wherein
the firmware that operates in each of the plurality of unit devices periodically accesses the multivibrator to cause output of the multivibrator to indicate normal operation.

3. The information processing device according to claim 1, wherein the processor coupled to
transfer, by using an update target number register that stores a predetermined number and order in the transfer of the setting data, the setting data to the plurality of unit devices.

4. The information processing device according to claim 1, wherein the processor coupled to
determine, from among the plurality of unit devices, the specific unit device in which a first storage device indicates that the operation is normal and a second storage device indicates that the update of setting data is completed.

5. A linking method executed by a computer, the linking method comprising:
receiving, from each of a plurality of unit devices included in an information processing device, a first output which indicates whether an operation is normal, each of the plurality of unit devices storing a firmware;
receiving, from each of the plurality of unit devices, a second output which indicates whether update of setting data used for operation management of the information processing device is completed;
identifying, from among the plurality of unit devices, a specific unit device by using the first output and the second output; and
performing the operation management of the information processing device by using the firmware stored in the specific unit device.

6. The linking method according to claim 7, wherein the linking method comprising
performing a multivibrator that outputs a determination result of whether or not the unit device is in normal operation, wherein
the firmware that operates in each of the plurality of unit devices periodically accesses the multivibrator to cause output of the multivibrator to indicate normal operation.

7. The linking method according to claim 6, wherein the linking method comprising
transferring, by using an update target number register that stores a predetermined number and order in the transfer of the setting data, the setting data to the plurality of unit devices.

8. The linking method according to claim 6, wherein the linking method comprising
determining, from among the plurality of unit devices, the specific unit device in which a first storage device indicates that the operation is normal and a second storage device indicates that the update of setting data is completed.
